(19) United States
(12) Patent Application Publication
(10) Pub. No.: US 2018/0175731 A1
(43) Pub. Date: Jun. 21, 2018

(54) CONTROLLING MULTIPLE-INPUT MULTIPLE-OUTPUT CONVERTERS

(71) Applicant: KONINKLIJKE PHILIPS N.V., EINDHOVEN (NL)

(72) Inventors: Albert GARCIA i TORMO, EINDHOVEN (NL); Hendrik HUISMAN, TILBURG (NL); Peter Lürkens, AACHEN (DE); Bernd ACKERMANN, AACHEN (DE)

(21) Appl. No.: 15/737,452

(22) PCT Filed: Jun. 29, 2016
(86) PCT No.: PCT/EP2016/065167

§ 371 Date: Dec. 18, 2017

(30) Foreign Application Priority Data
Jun. 30, 2015 (EP) 15174411.7

(51) Int. Cl. H02M 3/158; H02M 1/08; H02M 3/157

(52) U.S. Cl. CPC H02M 3/158; H02M 2001/009; H02M 3/157; H02M 1/08

(57) ABSTRACT

The present invention relates to a control device (1) for a multiple-input multiple-output converter (100) comprising: a first transformation block controller (21), which is configured to split outputs of the multiple-input multiple-output converter (100) into independent sets of outputs representing at least two independent virtual converters (100-1, 100-2, . . . , 100-n); a first converter controller (10), which is configured to control a first virtual converter (100-1) of the at least two independent virtual converters (100-1, 100-2, . . . , 100-n) by providing a first controlling signal based on the independent sets of outputs; a second converter controller (30), which is configured to control a second virtual converter (100-2) of the at least two independent virtual converters (100-1, 100-2, . . . , 100-n) by providing a second controlling signal based on the independent sets of outputs; and a second transformation block controller (22), which is configured to combine the first controlling signal and the second controlling signal into a set of combined control signals for driving the multiple-input multiple-output converter (100).

### FIELD OF THE INVENTION

The present invention relates to the field of Multiple-Input Multiple-Output, MIMO, switched-mode converter topologies. In particular, the present invention relates to a control device for controlling a MIMO converter, a MIMO converter, a high power pre-regulator for X-ray generation, and a method for controlling MIMO converters.

### BACKGROUND OF THE INVENTION

MIMO converters comprise at least two converters interconnected via their switches and/or reactive components. Each converter forming the MIMO converter has its own output and hence drives a different load. The output voltage and/or the output current can be different for each output of the MIMO converters; this is, for each of the converters forming the MIMO converter. Depending on the topology of the MIMO converter, the converters forming the MIMO converter may be interconnected (i.e. each input of the MIMO converter influences several outputs of the MIMO converter), thereby resulting in a cross-dependence which has to be considered in the design of the control loop of the MIMO converter. Controlling converters with such a cross-dependence may be prone to oscillations and unstable behaviour.

US 2009/0066311 A1 describes a pre-conditioner circuit comprising first and second pre-conditioner modules each having an input and an output, the outputs being coupled to respective load modules. The output of each pre-conditioner module is connected via inductors and power switches to the input of the other pre-conditioner module, such that an arbitrary series of serial and parallel connection of the load modules can be achieved.

TREVISAN ET AL: “Digital Control of Single-Inductor Dual-Output DC-DC Converters in Continuous-Conduction Mode”, POWER ELECTRONICS SPECIALISTS CONFERENCE, 2005. PESC '05. IEEE 36TH, IEEE, PISCATAWAY, N.J., USA, 1 Jan. 2005 (2005-01-01), pages 2616-2622, discloses the application of digital control for non-isolated single-inductor dual-output step-down de-de converters operating in Continuous-Conduction Mode (CCM).

WEIWEI XU ET AL: “A single-inductor dual-output switching converter with low ripples and improved cross regulation”, CUSTOM INTEGRATED CIRCUITS CONFERENCE, 2009. CICC '09. IEEE, IEEE, PISCATAWAY, N.J., USA, 13 Sep. 2009 (2009-09-13), pages 303-306, discloses a fly capacitor method for single-inductor dual-output (SIDO) switching converters to reduce the output ripples and spikes.

### SUMMARY OF THE INVENTION

There may be a need to improve control devices and methods for controlling a MIMO converter.

These needs are met by the subject-matter of the independent claims. Further exemplary embodiments are evident from the dependent claims and the following description.

An aspect of the present invention relates to a control device for controlling a multiple-input multiple-output converter comprising: a first transformation block controller, which is configured to split outputs of the multiple-input multiple-output converter into independent sets of outputs representing at least two independent virtual converters; a first converter controller, which is configured to control a first virtual converter of the at least two independent virtual converters by providing a first controlling signal based on a first independent set of outputs; a second converter controller, which is configured to control a second virtual converter of the at least two independent virtual converters by providing a second controlling signal based on a second independent set of outputs; and a second transformation block controller, which is configured to combine the first controlling signal and the second controlling signal into a set of combined control signals for driving the multiple-input multiple-output converter.

In other words, the present invention advantageously provides a control procedure for MIMO converters, wherein the control procedure provides a detaching of the virtually modelled converters forming the MIMO converter so that these virtual independent converters can be independently controlled. Explicitly the independence of the outputs should be emphasized. If e.g. one of the independent outputs is used by two virtual converters, then the virtual converters are not independent anymore. This is incompatible with the present concept.

The term“independent set of outputs” as used by the present invention may refer to signals which are at least partially detached or separated. In other words, the independent sets of outputs may comprise signals which are additionally detached or which are additionally separated if compared to the outputs of the multiple-input multiple-output converter.

In other words, the independent sets of outputs may be regarded as to comprise a lower level of signal correlation if compared to the outputs of the multiple-input multiple-output converter.

For example, the MIMO converter may be an interleaved buck converter, which comprises two inputs and two outputs; the procedure may be based in controlling the common-mode and the differential-mode signals of both buck converters together. The transformation block controller may comprise two transformation blocks in terms of matrix blocks which allow interpreting the interleaved topology as two independent buck converters.

For example, the MIMO converter may be a converter which may be split into N virtual converters, wherein N is equal to or greater than two, e.g. into any number higher than two of independent virtual converters.

For instance, one converter of the two independent virtual converters may be a common-mode converter and the other one of the two independent virtual converters may be a differential-mode converter. The transformation blocks may implement different operations depending on the converter topology. For the example of the interleaved buck converter topology, evaluating the common-mode and the differential-mode of the two voltages and the currents may be sufficient. The present invention advantageously allows detaching the interconnected virtual converters forming a MIMO converter.

According to a further, second aspect of the present invention, a MIMO converter is provided, the MIMO converter comprising a control device according to the first aspect of the present invention or according to any implementation form of the first aspect of the present invention.

According to a further, third aspect of the present invention, a high power pre-regulator for X-ray generation is provided. The high power pre-regulator for X-ray generation may comprise at least one MIMO converter according to the second aspect of the present invention or according to any implementation form of the second aspect of the present invention.

According to a further, fourth aspect of the present invention, a method for controlling a MIMO converter is provided, the method comprising the steps of:

a) Splitting outputs of the multiple-input multiple-output converter into independent sets of outputs representing at least two independent virtual converters;
b) controlling a first virtual converter of the at least two independent virtual converters by providing a first controlling signal based on a first independent set of outputs;
c) controlling a second converter of the at least two independent virtual converters by providing a second controlling signal based on a second independent set of outputs; and
d) combining the first controlling signal and the second controlling signal into a set of combined control signals for driving the multiple-input multiple-output converter.

According to an exemplary embodiment of the present invention, the first transformation block controller is configured to split the outputs of the multiple-input multiple-output converter into common-mode signals for the first virtual converter and into differential-mode signals for the second virtual converter. In other words, for the case of an interleaved buck converter, the transformation block is configured to split the interleaved buck converter topology by controlling the common-mode and differential-mode signals of the first buck converter and of the second buck converter combined together. This advantageously allows independently controlling the two outputs of the interleaved buck converter.

According to an exemplary embodiment of the present invention, the first transformation block controller and/or the second transformation block controller are in form of a digital electronic circuit or in form of an analogue electronic circuit or in form of a mixed digital-analogue electronic circuit. This advantageously provides improved transformation block controller performance so that both converters can be independently controlled.

According to an exemplary embodiment of the present invention, a first transformation block of the at least two transformation blocks is configured to provide a set of independent or separated state variables. This advantageously provides that it is possible to define independent transfer functions.

According to an exemplary embodiment of the present invention, a second transformation block of the at least two transformation blocks is configured to recombine the control signals provided by the controllers of the independent converters to control the MIMO converter. The MIMO converter may be an interleaved buck converter. This advantageously provides that it is possible to define independent transfer functions for the common-mode and the differential-mode converters and thus it allows independently controlling the two outputs of the interleaved buck converter.

According to an exemplary embodiment of the present invention, the first converter controller is configured to provide control for the first virtual converter.

According to an exemplary embodiment of the present invention, the second converter controller is configured to provide control for the second virtual converter. This advantageously provides that the differential-mode transfer functions only depend upon the differential-mode of the duty cycle of the MIMO converter, whereas the common-mode transfer functions only depend upon the common-mode of the duty cycle of the MIMO converter.

According to an exemplary embodiment of the present invention, the first converter controller is a proportional controller, or an integral controller, or a derivative controller, or a proportional-integral controller, or a proportional-derivative controller, or a derivative-integral controller, or a proportional-integral-derivative controller. This advantageously provides maintaining a desired system performance of the interleaved buck controller despite disturbances.

According to an exemplary embodiment of the present invention, the second converter controller is a proportional controller, or an integral controller, or a derivative controller, or a proportional-integral controller, or a proportional-derivative controller, or a derivative-integral controller, or a proportional-integral-derivative controller. This advantageously provides maintaining a desired system performance of the interleaved buck controller despite disturbances.

A computer program performing the method of the present invention may be stored on a computer-readable medium. A computer-readable medium may be a floppy disk, a hard disk, a CD, a DVD, an USB (Universal Serial Bus) storage device, a RAM (Random Access Memory), a ROM (Read Only Memory) and an EPROM (Erasable Programmable Read Only Memory). A computer-readable medium may also be a data communication network, for example the Internet, which allows downloading a program code.

The method, system and device described herein may be implemented as software in Digital Signal Processor, DSP, in a micro-controller or in any other side-processor such as a hardware circuit within an application specific integrated circuit, ASIC, CPLD or FPGA.

The present invention can be implemented in digital electronic circuitry, or in computer hardware, firmware, software, or in combinations thereof, e.g. in available hardware of a device or in new hardware dedicated for processing the methods described herein.

### BRIEF DESCRIPTION OF THE DRAWINGS

A more complete appreciation of the present invention and the attendant advantages thereof will be more clearly understood by reference to the following schematic drawings, which are not to scale, wherein:

FIG. 1 shows a schematic diagram of a MIMO interleaved buck converter according to an exemplary embodiment of the present invention;

FIG. 2 shows a schematic diagram of a multiple-input single-output MISO interleaved boost converter for explaining the present invention;

FIG. 3 shows a multiple-input single-output MISO interleaved buck converter for explaining the present invention;

FIG. 4 shows a MIMO interleaved buck converter with the transformation blocks which allow splitting of the topology into two independent virtual converter topologies according to an exemplary embodiment of the present invention;

FIG. 5 shows a MIMO converter with the transformation blocks which allow splitting outputs of the multiple-input multiple-output converter into independent sets of outputs of virtual converters according to an exemplary embodiment of the present invention;

FIG. 6 shows a schematic diagram of an implementation example of the two transformation blocks according to an exemplary embodiment of the present invention;

FIG. 7 shows a schematic diagram of a high power pre-regulator according to an exemplary embodiment of the present invention; and

FIG. 8 shows a schematic flow-chart diagram of a method for controlling an interleaved buck converter according to an exemplary embodiment of the present invention.

### DETAILED DESCRIPTION OF EMBODIMENTS

The illustration in the drawings is purely schematic and does not intend to provide scaling relations or size information. In different drawings or figures, similar or identical elements are provided with the same reference numerals. Generally, identical parts, units, entities or steps are provided with the same reference symbols in the description.

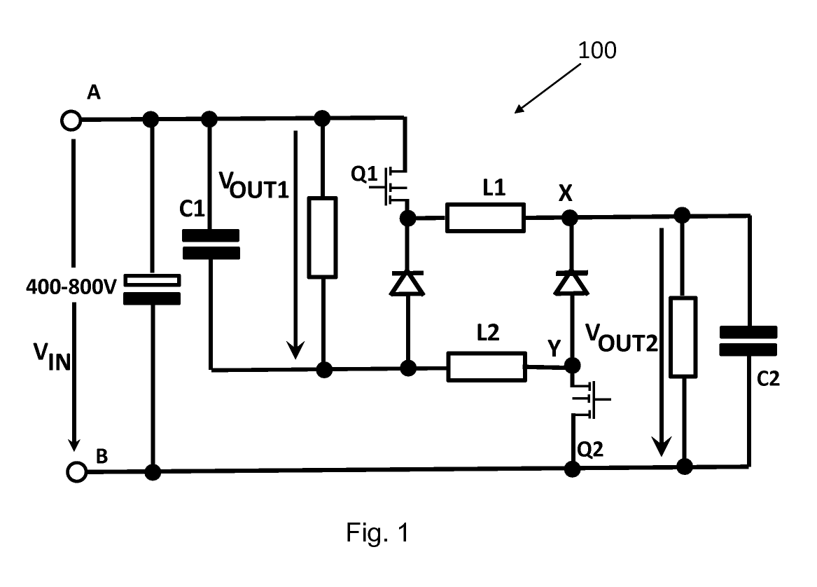

FIG. 1 shows a schematic diagram of a MIMO interleaved buck converter 100 according to an exemplary embodiment of the present invention.

The interleaved buck converter 100 as shown in FIG. 1 is a dual converter topology. The interleaved buck converter 100 comprises two buck converters, interconnected via their switches; each converter of the two buck converters has its own output and hence each converter drives a different load. The output voltage and/or the output current can be different in each output.

Referring to FIG. 1, there is illustrated a circuit implementation of the interleaved buck converter according to an exemplary embodiment of the present invention. In the case of the circuit of FIG. 1, the main applications, (i.e. the loads) are considered to be simple resistors which are provided with voltages V_{OUT1}, V_{OUT2}. An input voltage VG or V_{IN} is provided to the interleaved buck converter. The input voltage may be for instance between 400 V and 800 V.

The interleaved buck converter 100 may further comprise two transistors or switches Q1, Q2. The switches Q1, Q2 may be provided by metal-oxide-semiconductor field-effect transistor (MOSFET, MOS-FET, or MOS FET) or by n-channel IGFETs (Insulated Gate Field Effect Transistor) or by diodes or by transistors.

The interleaved buck converter 100 may further comprise capacitors C1, C2, which are used as filter capacitors and which provide a reduced ripple. The interleaved buck converter 100 may further comprise two diodes.

According to an exemplary embodiment of the present invention, the inductors L1, L2 that are used in interleaved buck converter have the same inductance.

According to an exemplary embodiment of the present invention, the capacitors C1 and C2 used in the interleaved buck converter have the same value.

Because of the interconnection, the current through each load, i.e. i_{L1} or i_{L2}, is partially shared between both inductors, which relaxes the specifications for the inductors but, at the same time, results in a cross-dependence between both converters. Indeed, Equation (1) states that,

i_{L1}=f(V_{G},V_{OUT1},V_{OUT2},D₁) i_{L2}=f(V_{G},V_{OUT1},V_{OUT2},D₂) (1)

where D₁ and D₂ stand for the duty cycle of each switch, V_{G} stands for the external voltage supplied to the interleaved buck converter, V_{OUT1}, V_{OUT2} stand for the voltage of the two capacitors (outputs of the interleaved buck converter).

From the control standpoint, if dynamic models are to be derived (the first step in the design of controllers according to classical control theory), this would result in control-to-output transfer functions which depend upon both D₁ and D₂, which hardens indeed the control loop design. Equation (2) denotes as follows:

V_{OUT1}=f(D₁,D₂) V_{OUT2}=f(D₁,D₂) (2)

Even though interleaved converter topologies are well-known (namely conventional interleaved topologies), these conventional converter topologies correspond to a completely different concept. Indeed conventional interleaved converter topologies are defined by parallel-connecting several identical converters, whose output comprises a capacitor (constant output voltage). All the output stages (i.e. the output capacitors) are connected in parallel, thus they are often merged into a single one, namely C. The remaining sets of inductor and switch are then parallel-connected to C. This structure can be applied to N converters.

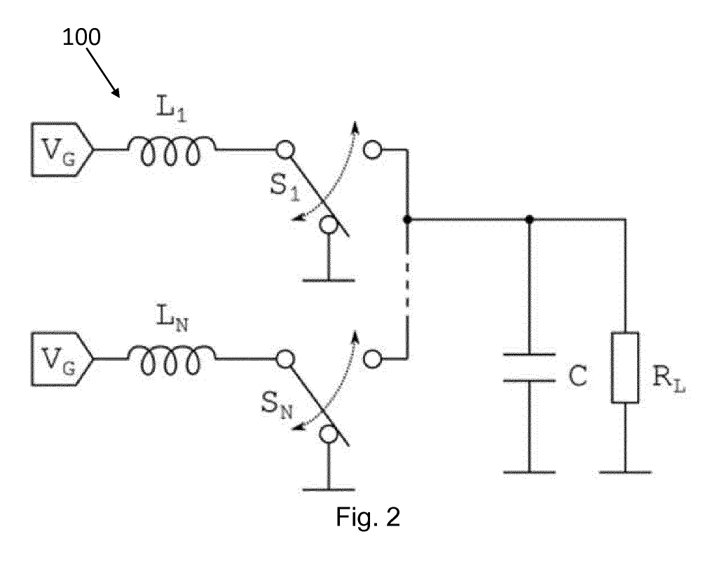

FIG. 2 shows a schematic diagram of a conventional Multiple-Input Single-Output (MISO) interleaved boost converter 100 for explaining the present invention.

An interleaved converter topology, see FIG. 2, may be defined by parallel-connecting several identical converters, whose output comprises a capacitor C (constant output voltage). The output stages (i.e. the output capacitors) are connected in parallel, thus they are often merged into a single one, namely C. The remaining sets of inductors L₁, . . . , L_{N} and switches S₁, . . . , S_{N} are then parallel-connected to C. This structure can be applied to N converters. Unlike the MIMO interleaved buck converter topology, this MISO interleaved buck converter topology comprises only one output and therefore is straightforward to be controlled. It is even possible to control this topology with just one control signal and reuse it for all switches (i.e. all switches are activated at the same time); nevertheless, in an implementation, phase-shifts in the control signals are introduced for balancing purposes.

According to an exemplary embodiment of the present invention, the converter 100 as shown in FIG. 2 comprises at least two transistors or switches S₁, . . . , S_{N}. In the case of the circuit of FIG. 2, the main circuit supplied by the converter 100, (i.e. the load) is considered to be simple resistor R_{L}. VG defines the external voltage supplied to the converter 100.

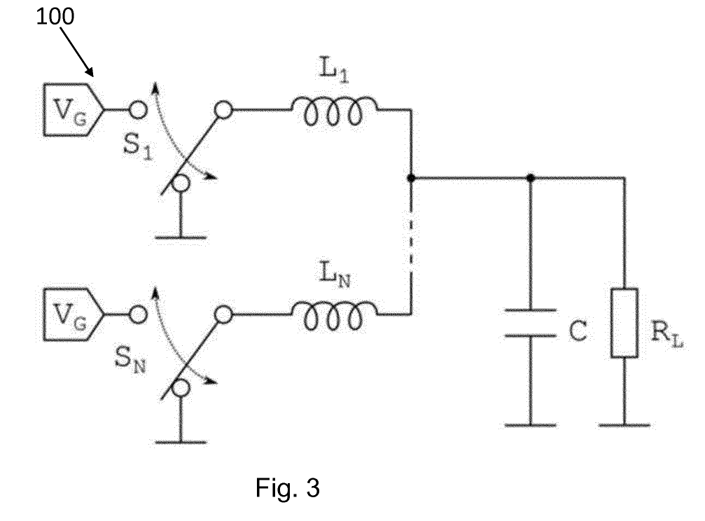

FIG. 3 shows an example of the MISO interleaved buck converter 100 for explaining the present invention. FIG. 3 shows the same parallel connection of several stages for conventional interleaved buck converters as already discussed in connection with FIG. 2. This MISO topology could also be controlled with just one control loop, which is often the case. Even if each converter would have its own control loop, the parallel connection of these converters would not affect their individual control loops, i.e. each individual converter could still be independently controlled of the others, as long as all controllers share the same reference signal (otherwise it would be like parallel-connecting voltage sources of different value).

According to an exemplary embodiment of the present invention, each inductor is connected either to an external voltage (VG or GND) or to the output voltage, which is directly controllable as defined in following Equation (3).

i_{Lj}=f(V_{G},Vₒ,Dⱼ) j=[1, . . . ,N] (3)

The different control signals for these parallel-connected converters may be driven with phase-shifts, which minimize the ripple in the output capacitor C.

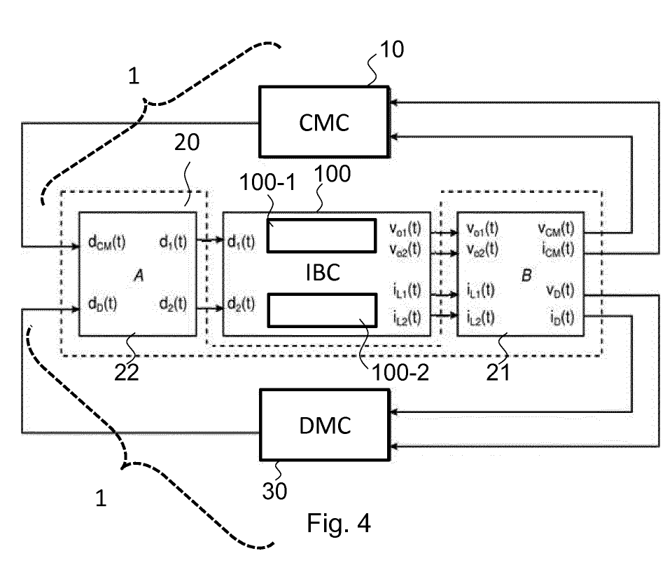

The further reference signs as shown in FIG. 3 were already described in the description of FIG. 1 and of FIG. 2 and are therefore not discussed any further. FIG. 4 shows a MIMO interleaved buck converter with the transformation blocks which allow splitting of the topology into two independent virtual converters according to an exemplary embodiment of the present invention.

A control device 1 comprises a first transformation block controller 21, a second transformation block controller 22, a first converter controller 10, and a second converter controller 30. The first transformation block controller 21 and the second transformation block controller 22 may form a combined transformation block controller 20.

The first transformation block controller 21 is configured to split outputs V_{O1}(t), V_{O2}(t), i_{L1}(t), i_{L2}(t) of the multiple-input multiple-output converter 100 into independent sets of outputs V_{CM}(t), i_{CM}(t) and V_{D}(t), i_{D}(t) representing at least two independent virtual converters 100-1, 100-2. In other words, the multiple-input multiple-output converter 100 may comprise or may be modelled using the first virtual converter 100-1 and the second virtual converter 100-2.

The multiple-input multiple-output converter 100 may also comprise more than two virtual converters and may still be controlled by the control device 1 comprising the first transformation block controller 21 and the second transformation block controller 22.

The first converter controller 10 is configured to control a first virtual converter 100-1 of the at least two independent virtual converters 100-1, 100-2 by providing a first controlling signal d_{CM}(t) based on the first independent set of outputs.

The second converter controller 30 is configured to control a second virtual converter 100-2 of the at least two independent virtual converters 100-1, 100-2 by providing a second controlling signal d_{D}(t) based on the second independent set of outputs.

The second transformation block controller 22 is configured to combine the first controlling signal d_{CM}(t) and the second controlling signal d_{D}(t) into a set of combined control signals d₁(t), d₂(t) for driving the multiple-input multiple-output converter 100.

According to an exemplary embodiment of the present invention, the combined transformation block controller 20 is configured to split the interleaved buck converter 100 into a first virtual converter 100-1 and a second virtual converter 100-2 by controlling its common-mode and differential-mode signals.

According to an exemplary embodiment of the present invention, the transformation block controller 20 comprises at least two transformation blocks 21, 22, namely the first transformation block controller 21 and the second transformation block controller 22, which are in form of a digital electronic circuit or in form of an analogue electronic circuit or in form of a mixed digital-analogue electronic circuit.

The first transformation block controller 21 and/or the second transformation block controller 22 may be configured to interpret the interleaved buck converter as two independent converters (namely common-mode converter and differential-mode converter).

The transformation blocks A and B in form of these transformation blocks may implement different operations depending on the converter topology. In this case, the interleaved buck converter topology, evaluating the common-mode and the differential-mode of the two voltages and the two currents is enough, resulting in Equation (4):

$$( \begin{matrix}{v}_{o 1} ( t ) \\ {v}_{o 2} ( t )\end{matrix} ) = \underbrace{( \begin{matrix}1 & \frac{1}{2} \\ 1 & - \frac{1}{2}\end{matrix} )}_{{A}_{\underline{\_}}} ( \begin{matrix}{v}_{CM} ( t ) \\ {v}_{D} ( t )\end{matrix} ) \\ ( \begin{matrix}{v}_{CM} ( t ) \\ {v}_{D} ( t )\end{matrix} ) = \underbrace{( \begin{matrix}\frac{1}{2} & \frac{1}{2} \\ 1 & - 1\end{matrix} )}_{{B}_{\underline{\_}}} ( \begin{matrix}{v}_{o 1} ( t ) \\ {v}_{o 2} ( t )\end{matrix} ) \qquad ( 4 )$$

The A and B matrices of Equation (4) can be easily implemented with analogue or digital circuitry implemented in the first transformation block controller 21 and/or the second transformation block controller 22.

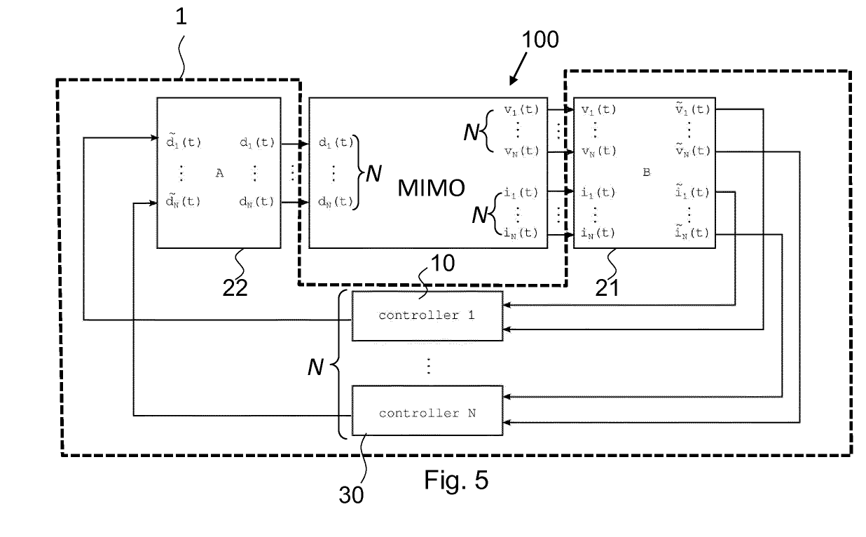

FIG. 5 shows an interleaved buck converter with the transformation blocks which allow splitting of the topology into independent converters according to an exemplary embodiment of the present invention. FIG. 5 illustrates the embodiment with a number of more than two independent converters present.

According to an exemplary embodiment of the present invention, the two transformation block controllers 21, 22 are used to control the MIMO converter 100, regardless of the number N of independent virtual converters 100-1, 100-2, . . . , 100-n. A corresponding number of convert controllers 10, 30 may be used according to the number N of independent virtual converters 100-1, 100-2, . . . , 100-n.

According to an exemplary embodiment of the present invention, the number of state variables in the MIMO converter and per virtual converter may also vary depending on the topology.

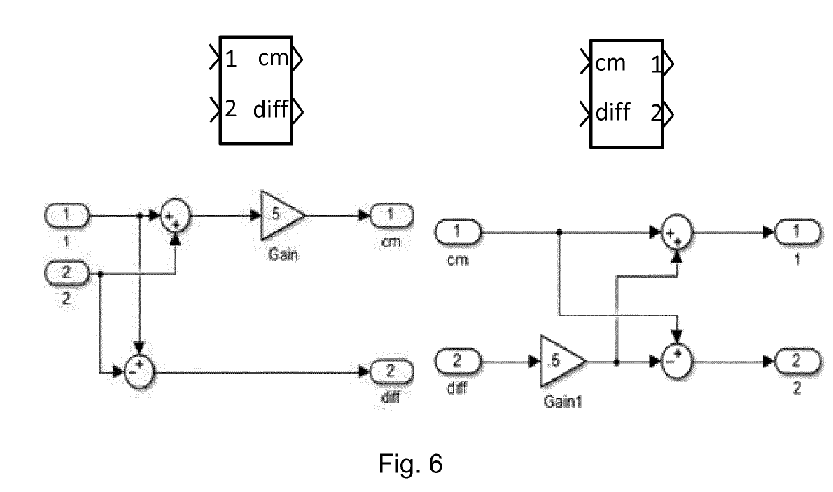

FIG. 6 shows a schematic diagram of an implementation example of the transformation blocks according to an exemplary embodiment of the present invention. FIG. 6 shows an example of how to implement the transformation blocks with analogue circuitry.

The common-mode and differential-mode control blocks may be a loop feedback controller, such as a proportional controller, or an integral controller, or a derivative controller, or a proportional-integral controller or a proportional-integral-derivative controller.

According to an exemplary embodiment of the present invention, relying on this transformation, it is possible to define independent transfer functions for the common-mode and the differential-mode converters, i.e. the transformation blocks A and B, for the interleaved buck converter. This may be defined as stated by Equation 5:

$$\{ \begin{matrix}{G}_{{\hat{V}}_{D}} ( s ) = \frac{{\hat{V}}_{D} ( s )}{{\hat{D}}_{D} ( s )} \\ {{G}_{\hat{I}}}_{D} ( s ) = \frac{{\hat{I}}_{D} ( s )}{{\hat{D}}_{D} ( s )}\end{matrix} \\ \{ \begin{matrix}{G}_{{\hat{V}}_{CM}} ( s ) = \frac{{\hat{V}}_{CM} ( s )}{{\hat{D}}_{CM} ( s )} \\ {G}_{{\hat{I}}_{CM}} ( s ) = \frac{{\hat{I}}_{CM} ( s )}{{\hat{D}}_{CM} ( s )}\end{matrix} \qquad ( 5 )$$

The differential-mode transfer functions of Equation 5 only depend upon the differential-mode of the duty cycle, whereas the common-mode transfer functions only depend upon the common-mode of the duty cycle.

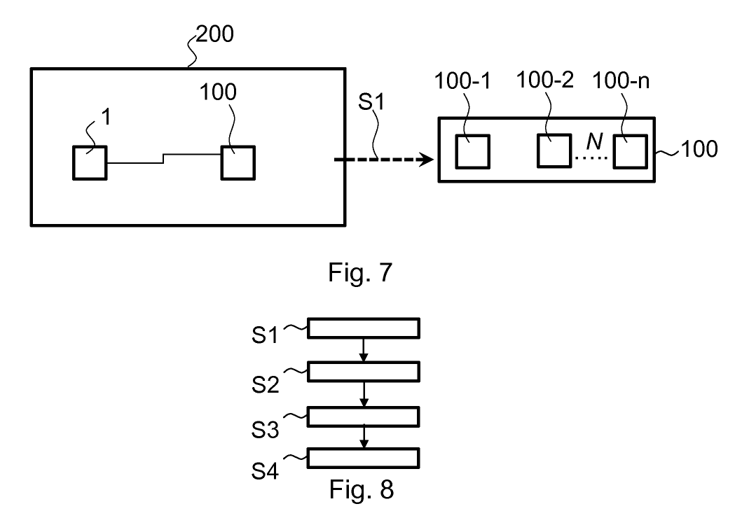

FIG. 7 shows a schematic diagram of high power pre-regulator according to an exemplary embodiment of the present invention.

On the left side of FIG. 7, a high power pre-regulator 200 for X-ray generation is shown which may comprise at least one MIMO converter 100, and a control device 1.

On the right side of FIG. 7, the modelling of the MIMO converter 100 by splitting S1 the outputs of the multiple-input multiple-output converter 100 is shown, the process of the modelling—or in other words, of the splitting S1—is represented by the dashed arrow.

The first transformation block controller 21 is configured to split outputs of the multiple-input multiple-output converter 100 into independent set of outputs representing at least two independent virtual converters 100-1, 100-2. More than two independent virtual converters 100-1, 100-2, 100-n may be used, for instance, N virtual converters as shown in FIG. 7.

FIG. 8 shows a schematic flow-chart diagram of a method for controlling an interleaved buck converter according to an exemplary embodiment of the present invention.

The method for controlling a MIMO converter may comprise the following steps:

As a first step a) of the method, splitting S1 outputs of the multiple-input multiple-output converter 100 into independent sets of outputs representing at least two independent virtual converters 100-1, 100-2, . . . , 100-n may be conducted. In other words, splitting a MIMO converter topology into at least two independent converter topologies may be conducted.

As a second step b) of the method, controlling S2 a first virtual converter 100-1 of the at least two independent virtual converters 100-1, 100-2, . . . , 100-n by providing a first controlling signal may be conducted. In other words, controlling S2 a converter 100-1 of the MIMO converter 100 based on a first topology of the at least two independent converter topologies may be conducted.

As a third step c) of the method, controlling S3 a second virtual converter 100-2 of the at least two independent virtual converters 100-1, 100-2, . . . , 100-n by providing a second controlling signal may be conducted. In other words, controlling S3 a second buck converter 100-2 of the interleaved buck converter 100 based on a second topology of the at least two independent converter topologies may be conducted.

As a fourth step d) of the method, combining S4 the first controlling signal and the second controlling signal into a set of combined control signals for driving the multiple-input multiple-output converter 100 may be conducted.

It has to be noted that embodiments of the present invention are described with reference to different subject-matters. In particular, some embodiments are described with reference to method type claims whereas other embodiments are described with reference to device type claims.

However, a person skilled in the art will gather from the above and the foregoing description that, unless otherwise notified, in addition to any combination of features belonging to one type of the subject-matter also any combination between features relating to different subject-matters is considered to be disclosed with this application.

However, all features can be combined providing synergetic effects that are more than the simple summation of these features.

While the present invention has been illustrated and described in detail in the drawings and the foregoing description, such illustration and description are to be considered illustrative or exemplary and not restrictive; the present invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. A single processor or controller or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. A control device for a multiple-input multiple-output converter comprising:
a first transformation block controller, which is configured to split outputs of the multiple-input multiple-output converter into independent sets of outputs representing at least two independent virtual converters;
a first converter controller, which is configured to control a first virtual converter of the at least two independent virtual converters by providing a first controlling signal based on a first independent set of outputs;
a second converter controller, which is configured to control a second virtual converter of the at least two independent virtual converters by providing a second controlling signal based on a second independent set of outputs; and
a second transformation block controller, which is configured to combine the first controlling signal and the second controlling signal into a set of combined control signals for driving the multiple-input multiple-output converter.

2. Control device according to claim 1,
wherein the first transformation block controller is configured to split the outputs of the multiple-input multiple-output converter into common-mode signals for the first virtual converter and into differential mode signals for the second virtual converter.

3. Control device according to claim 1,
wherein the first transformation block controller and/or the second transformation block controller are in form of a digital electronic circuit or in form of an analogue electronic circuit or in form of a mixed digital-analogue electronic circuit.

4. Control device according to claim 2,
wherein the first transformation block controller is configured to provide a set of independent state variables.

5. Control device according to claim 1,
wherein the second transformation block controller is configured to recombine the control signals provided by the controllers of the independent converters to control the multiple-input multiple-output converter.

6. Control device according to claim 1,
wherein the first converter controller is configured to provide control for the first virtual converter.

7. Control device according to claim 6,
wherein the second converter controller (30) is configured to provide control for the second virtual converter.

8. Control device according to claim 7,
wherein the first converter controller is a proportional controller, or an integral controller, or a derivative controller, or a proportional-integral controller, or a proportional-derivative controller, or a derivative-integral controller, or a proportional-integral-derivative controller.

9. Control device according to claim 1,
wherein the second converter controller is a proportional controller, or an integral controller, or a derivative controller, or a proportional-integral controller, or a proportional-derivative controller, or a derivative-integral controller, or a proportional-integral-derivative controller.

10. A multiple-input multiple-output converter comprising a control device according to claim 1.

11. A high power pre-regulator for X-ray generation comprising at least one multiple-input multiple-output converter according to claim 10.

12. A method for controlling multiple-input multiple-output converter, the method comprising the steps of:
a) Splitting outputs of the multiple-input multiple-output converter into independent sets of outputs representing at least two independent virtual converters;
b) controlling a first virtual converter of the at least two independent virtual converters by providing a first controlling signal based on a first independent set of outputs;
c) controlling a second converter of the at least two independent virtual converters by providing a second controlling signal based on a second independent set of outputs; and
d) combining the first controlling signal and the second controlling signal into a set of combined control signals for driving the multiple-input multiple-output converter.

13. Method according to claim 12,
wherein the step of splitting the outputs of the multiple-input multiple-output converter into the independent sets of outputs representing at least two independent virtual converters is conducted by controlling common-mode and differential mode signals of the first virtual converter and of the second virtual converter.

14. Method according to claim 12,
wherein common-mode control is provided for the first virtual converter by a first converter controller.

15. Method according to according to claim 12,
wherein differential-mode control is provided for the second virtual converter by a second converter controller.
